(19) United States
(12) Patent Application Publication
(10) Pub. No.: US 2011/0012523 A1
(43) Pub. Date: Jan. 20, 2011

(54) METHOD AND CURRENT CONTROL CIRCUIT FOR OPERATING AN ELECTRONIC GAS DISCHARGE LAMP

(75) Inventor: Andries Cornelis Pasma, Nuis (NL)

Correspondence Address: YOUNG & THOMPSON, 209 Madison Street, Suite 500, Alexandria, VA, 22314, US

(73) Assignee: A.C. PASMA HOLDING B.V. [, Nuis (NL)

(21) Appl. No.: 12/670,638

(22) PCT Filed: Jul. 24, 2007
(86) PCT No.: PCT/NL07/00189

§ 371 Date: Sep. 10, 2010

(51) Int. Cl. H05B 41/36

(52) U.S. Cl. 315/246; 315/307

(57) ABSTRACT

In a method for operating an electronic gas discharge lamp by a TRIAC circuit, a current is drawn from the dimmer circuit when the TRIAC is in a non-conductive state to bring the TRIAC in the conductive state and the current drawn from the dimmer circuit is reduced when the TRIAC is in a conductive state. According to the invention a substantially fixed current is drawn from the dimmer circuit in the conductive state of the TRIAC at a sufficient level to maintain the TRIAC in the conductive state. To this end a current control circuit for controlling a current drawn from a power source including a voltage controlled variable resistive switch circuit driven by a voltage control circuit.

The present invention relates to a method for operating an electronic gas discharge lamp by means of a TRIAC circuit, in which a current is drawn from the dimmer circuit when the TRIAC is in a non-conductive state to bring the TRIAC in the conductive state and the current drawn from the dimmer circuit is reduced when the TRIAC is in a conductive state. The invention further relates to a current control circuit for controlling a current drawn from a power source and to a ballast, assembly and dimmer circuit comprising such a current control circuit.

Common standard dimmer circuits employ a TRIAC in order to shape an alternating supply voltage such as a mains voltage. When an alternating supply voltage such as a mains voltage is at a zero crossing, and therefore the current is at a zero crossing, the TRIAC is in a non-conductive state. When the supply voltage increases, a load connected to the dimmer circuit draws current. After a period of time, determined by a timing circuit of the TRIAC dimmer circuit, the TRIAC becomes conductive and the lamp is fed with a voltage and a corresponding current. The current keeps the TRIAC in a conductive state until the supply current approaches again a zero level. Said period of time, determined by the TRIAC dimmer circuit, may be user-adjustable by additional circuitry of the TRIAC dimmer circuit.

A gas discharge lamp operated by an electronic ballast, commonly employed as an energy-saving lamp, only draws current from the supply in the peaks of the alternating voltage due to the presence of a buffer capacitor in the electronic ballast. However, the common TRIAC dimmer circuit is only suitable for use with a resistive load. The load should draw current from the voltage supply during the entire cycle of the alternating voltage in order for the TRIAC dimmer circuit to function properly. Therefore, TRIAC dimmer circuits are commonly used for dimming incandescent lamps only. For dimming an electronic energy-saving gas discharge lamp, a TRIAC dimmer circuit generally does not function the way it should.

In U.S. Pat. No. 6,452,343 it is proposed to provide a circuit having a resistive characteristics, for instance a resistor, between the input terminals of a ballast circuit of a gas discharge lamp. Thus, a TRIAC dimmer circuit is provided with a resistive load and may function properly, regardless the type of lamp. This solution, however, results in a substantial power loss, since a current flows through the resistive circuit at any time. Moreover, when the TRIAC is conductive, only a small current needs to be drawn to keep the TRIAC in its conductive state, whereas when the voltage is near its peak value a large current flows through the resistive circuit.

International patent application PCT/IB2006/120629 discloses a method and circuit for operating an electronic gas discharge lamp which attempts to alleviate the above drawback such that the lamp is dimmable using a TRIAC dimmer circuit with low power loss. This known circuit comprises a resistor connected in series with a parallel circuit of a first switch and a series connection of a second switch and a further resistor. The first and second switch are controlled by the voltage power source such that the first switch is conductive when the supply voltage is below a certain threshold level and the second switch is conductive when the supply voltage is above said threshold level. A voltage divider of two resistors is connected in parallel to the control circuit to put the control voltages of the switches on the right level. A node of said voltage divider between said resistors is coupled to a control terminal of the first switch.

Although this known circuit reduces the power dissipation within the control circuit, the voltage divider will inevitably still draw a certain current at all times and hence still lead to a certain power loss. Moreover the current drawn by this known load circuit will change with the level of the supply voltage and hence will often be higher than necessary to keep the TRIAC on.

It is an object of the present invention inter alia to provide for a method and circuit of the kind described in the opening paragraph which is operable with a substantially lower power dissipation

In order to achieve said object a method of the type described in the opening paragraph is characterized in that a substantially fixed current is drawn from the dimmer circuit in the conductive state of the TRIAC at a sufficient level to maintain the TRIAC in the conductive state. By tuning said fixed current on a level just beyond a threshold level of the TRIAC the power loss caused by the load circuit is reduced to a minimal level in this manner, independent of the alternating level of the supply voltage. The method of the invention may be realised by a current control circuit according to the invention. To this end, a current control circuit for controlling a current drawn from a power source, according to the invention, comprises a voltage controlled variable resistive switch circuit driven by a voltage control circuit which is operatively connected to a supply voltage of said power source. A switch within the switch circuit behaves like a variable resistor which at any level of the supply voltages ensures a substantially constant current drawn by the current control circuit, which current is approximately defined by the voltage control circuit.

The method and the circuit advantageously draw a relatively large current, when the electronic gas discharge lamp and its electronic ballast is not drawing current, in order to charge the timing circuit and bring the TRIAC in a conductive state, and draw a reduced current, when only a small current is needed to keep the TRIAC of the dimmer circuit in a conductive state.

When the alternating supply voltage and current increases from zero at a start of a cycle, the TRIAC is in a non-conducting state. To bring the TRIAC in a conducting state, the load should draw current to charge the timing circuit of the TRIAC. Since the electronic gas discharge lamp does not draw current at this stage of the cycle of the alternating voltage and current, the current control circuit is designed to draw current, particularly by providing a resistive load, when the gas discharge lamp and its ballast circuit are not drawing current.

When the TRIAC has become conductive, only a small current is needed to keep the TRIAC in its conductive state. Therefore, the resistance of the load may be increased. The current control circuit according to the present invention is designed to keep this relatively small current at a sufficient level just beyond the threshold level of the TRIAC in order to minimize power dissipation. The variable resistance of the switch circuit is thereby controlled by the voltage level of the voltage control circuit, which is operatively connected to the supply voltage. If the supply voltage is a mains voltage of 230 V at 50 Hz, a suitable predetermined voltage level may be about 50 V.

In an embodiment the switches in the switch circuit are electronic switches such as transistors. In that embodiment, a control terminal of the transistors is operatively connected to the supply voltage.

In a specific embodiment the current control circuit according to the invention is characterized in that the switch circuit comprises a series connection of a switch and a first resistive circuit, a control terminal of said switch being operatively connected to the supply voltage of said power source through said voltage control circuit, and more particularly in that said switch comprises a bipolar transistor and in that said control terminal comprises a base of said bipolar transistor.

A further specific embodiment of the current control circuit according to the invention is characterized in that said voltage control circuit comprises a series connection of a second resistive circuit and a Zener diode, a node between said second resistive circuit and said Zener diode being operatively coupled to a control terminal of a switch of said switch circuit. The substantially fixed current drawn by this circuit is basically set by the voltage division between the Zener diode and the second resistive circuit. The switch acts as a variable resistor to ensure that independent of the supply voltage level the current thus defined by the Zener diode and the second resistive circuit flows through the current control circuit.

If the gas discharge lamp and the electronic ballast thereof draw sufficient current to keep the TRIAC in its conductive state, it may not be needed that an additional circuit draws any current. Therefore, in a preferred embodiment, the current control circuit is designed to control the total current drawn by the lamp and the resistive circuit, particularly by preventing a current from flowing through the resistive circuit when the assembly of the gas discharge lamp and electronic ballast is drawing sufficient current. To this end, a preferred embodiment of the current control circuit which according to the invention is characterized in that a third resistive circuit is connected in series between said second resistive circuit and said Zener diode, in that a further switch circuit, comprising a series connection of a second Zener diode and a further switch, is connected in parallel to the series connection of the third resistive circuit and the first Zener diode, a control terminal of said further switch being connected to a node between said third resistive circuit and said first Zener diode. In a specific embodiment the current control circuit according to the invention is further characterized in that said further switch is a device taken from a group comprising a bipolar transistor, a field effect transistor, a thyristor and a TRIAC.

The switch and third resistive circuit, together with the second Zener diode, form a switching circuit which turn off the current source once the lamp consumes power and itself ensures that the TRIAC remains in the conductive state. In the event the second Zener diode carries a current, the switch is in a conductive state to short cut the first Zener diode. The voltage drawn by the primary part of the current control circuit, being defined by the voltage division between the first Zener diode and the second resistive circuit, in that case reaches zero as the voltage drop over the first Zener diode diminishes in that event. A further reduction of the power dissipation within the current control circuit may be brought about in this manner.

The present invention further relates to a dimmer circuit for dimming an electronic gas discharge lamp, the dimmer circuit comprising a TRIAC dimmer circuit, a current control circuit according to the invention and a rectifier circuit connected between the TRIAC dimmer circuit and the current control circuit.

The invention moreover relates to a ballast circuit for operating a gas discharge lamp, the ballast circuit comprising a rectifier circuit for receiving a low frequency alternating voltage, an inverter circuit for providing a high frequency lamp current, and a current control circuit according to the present invention connected between the rectifier circuit and the inverter circuit, a buffer capacitor being connected between input terminals of the inverter circuit and a diode being connected between an output terminal of the current control circuit and a terminal of the buffer capacitor to prevent current being drawn from the buffer capacitor, and to an assembly of a gas discharge lamp and such a ballast circuit.

These and other aspects of the present invention will be apparent from and elucidated with reference to several embodiments described hereinafter and an accompanying drawing. The annexed drawing shows these non-limiting exemplary embodiments, wherein:

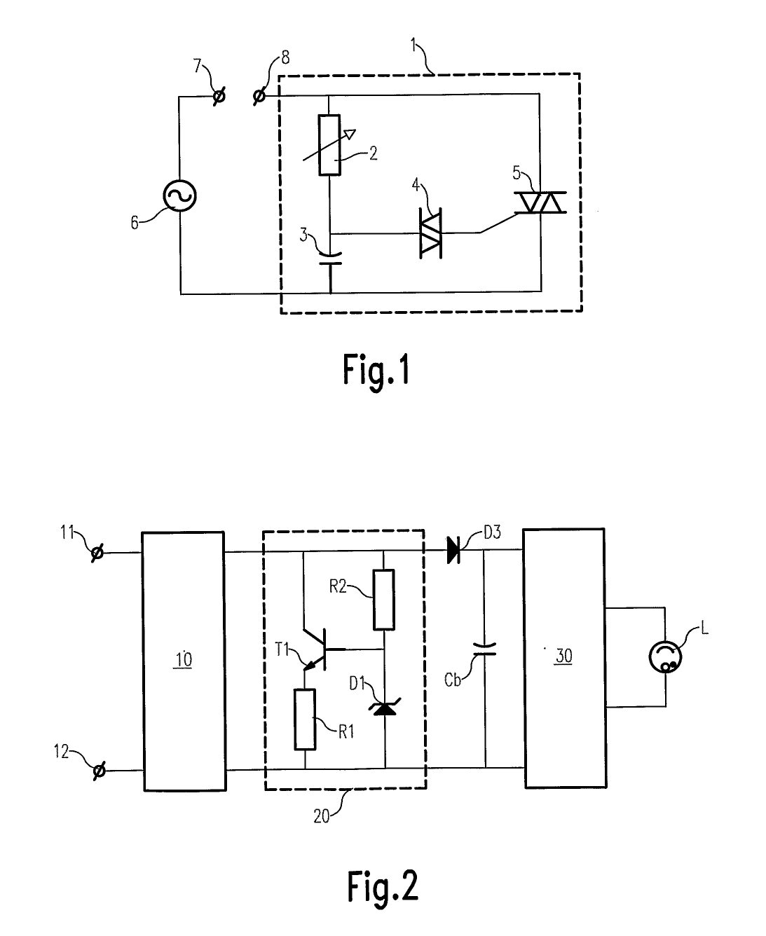

FIG. 1 shows a conventional TRIAC dimmer circuit;

FIG. 2 shows a diagram of an embodiment of a ballast circuit for operating a lamp comprising a current control circuit according to the present invention;

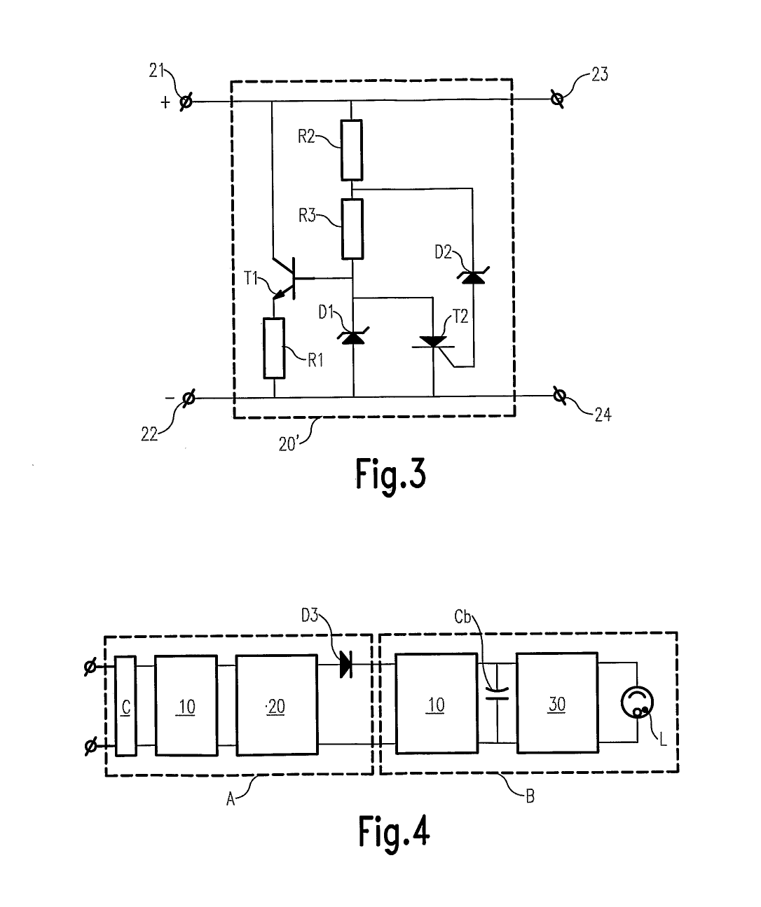

FIG. 3 shows a diagram of another embodiment of the current control circuit according to the present invention; and

FIG. 4 schematically illustrates a combination of a TRIAC dimmer circuit comprising a current control circuit and a commonly available energy-saving lamp.

In the drawings, identical reference numerals indicate similar components or components with a similar function.

FIG. 1 illustrates a conventional TRIAC dimmer circuit suitable for use with the method and circuit according to the present invention. The TRIAC dimmer circuit 1 comprises a resistor 2 having an adjustable resistance, a capacitor 3, a DIAC 4 and a TRIAC 5. A load such as a lamp is connectable between the terminals 7 and 8. The load and the TRIAC dimmer circuit 1 are connected in series to an AC power supply 6. It is noted that the resistor 2 may comprise a resistor having a static resistance or a resistor having a user-adjustable resistance, as is known in the art.

As illustrated, the capacitor 3 and the resistor 2 are connected in series between terminals of the TRIAC dimmer circuit 1. The TRIAC 5 is connected in parallel to the series connection of the resistor 2 and the capacitor 3. The DIAC 4 is connected between a control gate of the TRIAC 5 and a node between the capacitor 3 and the resistor 2. The resistor 2 and the capacitor 3 form the timing circuit of the TRIAC dimmer circuit 1.

In operation, when the voltage of the power supply 6 is zero, the DIAC 4 and the TRIAC 5 are in a non-conducting state. With an increasing voltage supplied by the AC power supply 6, the voltage over the capacitor 3 increases. When the voltage over the capacitor 3 reaches the breakover voltage of the DIAC 4, the capacitor 3 is partially discharged by the DIAC 4 into the TRIAC gate. As a result of the current provided to said TRIAC gate the TRIAC 5 becomes conductive. As long as a current flows through the TRIAC 5, the TRIAC 5 stays conductive. When the voltage supplied by the power supply 6 reaches zero again, the TRIAC 5 becomes non-conductive again.

From the above description of the operation a person skilled in the art readily understands that the load needs to draw a current from the TRIAC dimmer circuit 1, i.e. through the series connection of the resistor 2 and the capacitor 3, in order to charge the capacitor 3, when the TRIAC 5 is not conducting, in order to bring the TRIAC 5 in a conductive state.

FIG. 2 illustrates an electronic ballast circuit comprising a rectifier circuit 10, e.g. a diode bridge rectifier circuit, a current control circuit 20 and an inverter circuit 30. Two input terminals 11, 12 of the rectifier circuit 10 may be connected to a low frequency alternating supply voltage such as a mains voltage of 230 V at 50 Hz. The rectifier circuit 10 receives the supply voltage and outputs a rectified supply voltage.

The current control circuit comprises a first resistor R1, a second resistor R2, a transistor T1 and a diode D1. A node between the first resistor R2 and the diode D1 is connected to a control terminal (base) of the transistor T1. The collector of the transistor T1 is connected to the positive terminal of the supply voltage. The emitter of the transistor T1 is connected to the first resistor R1 and via R1 connected to the negative terminal of the rectified supply voltage.

A buffer capacitor Cb flattens the rectified voltage output by the rectifier circuit 10. The inverter circuit 30 is supplied with the rectified and flattened supply voltage and operates on the rectified supply voltage such that an output current of the inverter circuit 30 is suited for operating a gas discharge lamp L, e.g. an energy-saving compact fluorescent lamp.

The current control circuit 20 according to the present invention is provided to draw current from the supply source when the buffer capacitor Cb, the inverter circuit 30 and the gas discharge lamp L are not drawing current from the supply source, in order to enable use of a common, commercially available TRIAC dimmer circuit for dimming of the gas discharge lamp L.

Between the supply voltage source and the input terminals 11, 12 a dimmer circuit for dimming the gas discharge lamp L may be provided. To enable use of a common, commercially available TRIAC dimmer circuit, a current to charge the timing circuit needs to be drawn when the supply voltage on the load is low. Since the inverter circuit 30 only draws current from the supply source when the alternating supply voltage is high due to the presence of the buffer capacitor Cb, no or little current is drawn at the beginning of a cycle of the alternating voltage. Thus, there is not sufficient current drawn to charge the timing circuit of the TRIAC dimmer circuit in order to bring the TRIAC into a conductive state.

When the supply voltage is above zero volt the transistor T1 starts to conduct and a current may flow from collector to the emitter approximately predetermined by the voltage over the diode D1 and the first resister R1. When the voltage at the base of transistor T1 reaches the zener voltage of diode D1 the conducting current from collector to emitter in transistor T1 will stabilize at higher supply voltages.

For proper operation of the circuit, a diode may be connected between the buffer capacitor Cb and the current control circuit 20. The diode D3 prevents that a current drawn from the buffer capacitor Cb, when the supplied voltage, i.e. the output voltage of the rectifier circuit 10, is lower than the voltage over the buffer capacitor Cb. Further, for proper operation, the values of the resistors R1, R2 and the diode D1 assures that a TRIAC dimmer circuit connected between the rectifier circuit 10 and a supply source may function properly.

To ensure that a predetermined amount of current is only drawn before the ballast current starts flowing, the current control 20 may be provided with additional circuitry. FIG. 3 illustrates such a modified embodiment of a current control circuit 20′ having input terminals 21 and 22 for receiving a rectified supply voltage and output terminals 23 and 24 for supplying said voltage to an inverter circuit 30 as illustrated in FIG. 2.

Like the circuit illustrated in FIG. 2, the circuit of FIG. 3 comprises a transistor T1, a first resistor R1, a second resistor R2 and a diode D1. A second switch device T2 (e.g a bipolar transistor, MOSFET, Triac or Thyristor) is connected with its collector, drain or anode, as the case may be, to the base of the first transistor T1 and with its emitter, source, drain or cathode, as the case may be, to the negative supply voltage. The base or gate of the transistor T2 is connected to the cathode of a second diode D2 while the anode of the diode D2 is connected to the node between the second resistor R2 and a third resistor R3. The second resistor R2 is connected to the positive supply and the third resistor R3 is connected to the base of the first transistor T1. The second resistor R2 and a third resistor R3 function at the node with the second diode D2 as a voltage divider of the supply voltage. When this node reaches the zener voltage of diode D2, the second transistor T2 will become in a full conductive state between collector and emitter (d-s, a-c or d1-d2), connecting the base of the first transistor to the negative supply voltage. The first transistor T1 becomes in non-conductive state till the node between the resistors R2, R3 and the diode D2 becomes under de zener voltage of the diode D2 or even at zero volt when a triac T2 or thyristor T2 is applied. Further the values of the resistors R2, R3 and the diode D2 assure that the power dissipated by the first transistor T1 is reduced to lowest possible value.

In an embodiment for use with a mains voltage of 230 V at 50 Hz, the zener voltage of diode D1 may be 7.5 V and the resistance of the resistor R1 may be 1000 ohm. The resistance of the second resistor may be 100,000 ohm. In that embodiment a current of about 7 mA (7.5 V/1000 ohm) is drawn at maximum when the supply voltage is at the predetermined level or higher. It is noted that a current flows well through the voltage divider comprising the resistors R2, R3 and the diode D2. However, this current may be selected to be insignificantly small compared to the current from collector to emitter of the first transistor T1.

The electronic gas discharge lamp B as shown in FIG. 4 is a commonly available energy-saving lamp that may be connected directly to a mains voltage and is not dimmable using a standard TRIAC dimmer circuit. The TRIAC dimmer circuit assembly A comprises such a standard TRIAC dimmer circuit C and further comprises a current control circuit 20 according to the present invention, e.g. as shown in FIG. 2 or FIG. 3. For proper operation of the current control circuit 20, a rectifier circuit 10 and the diode D3 are as well provided in the TRIAC dimmer circuit assembly A. Thus, a simple TRIAC dimmer circuit assembly A may be provided with the use of which a common energy-saving lamp B, having an electronic ballast circuit, may be dimmed.

A person skilled in the art readily recognizes that the rectifier circuit 10 comprised in the electronic gas discharge lamp B is redundant in the circuit assembly of FIG. 4, since the voltage provided to the lamp assembly B is already rectified by the rectifier circuit 10 of the dimmer assembly A. The skilled person, therefore, also recognizes that the dimmer circuit assembly A may as well be employed in combination with an energy-saving lamp B having an electronic ballast without the rectifier circuit 10.

1. Method for operating an electronic gas discharge lamp by means of a TRIAC circuit, in which a current is drawn from the dimmer circuit (1) when the TRIAC (5) is in a non-conductive state to bring the TRIAC (5) in the conductive state and the current drawn from the dimmer circuit is reduced when the TRIAC is in a conductive state characterized in that a substantially fixed current is drawn from the dimmer circuit in the conductive state of the TRIAC at a sufficient level to maintain the TRIAC in the conductive state.

2. Current control circuit (20) for controlling a current drawn from a power source (6) comprising a voltage controlled variable resistive switch circuit driven by a voltage control circuit which is operatively connected to a supply voltage of said power source.

3. Current control circuit according to claim 2 characterized in that the switch circuit comprises a series connection of a switch (T1) and a first resistive circuit (R1), a control terminal of said switch being operatively connected to the supply voltage of said power source through said voltage control circuit.

4. Current control circuit according to claim 3 characterized in that said switch comprises a bipolar transistor and in that said control terminal comprises a base of said bipolar transistor.

5. Current control circuit according to claim 2, characterized in that said voltage control circuit comprises a series connection of a second resistive circuit (R2) and a Zener diode (D1), a node between said second resistive circuit and said Zener diode being operatively coupled to a control terminal of a switch of said switch circuit.

6. Current control circuit according to claim 5 characterized in that a third resistive circuit (R3) is connected in series between said second resistive circuit (R2) and said Zener diode (D1), in that a further switch circuit, comprising a series connection of a second Zener diode (D2) and a further switch (T2), is connected in parallel to the series connection of the third resistive circuit (R3) and the first Zener diode (D1), a control terminal of said further switch being connected to a node between said third resistive circuit (R3) and said first Zener diode (D1).

7. Current control circuit according to claim 6 characterized in that said further switch is a device taken from a group comprising a bipolar transistor, a field effect transistor, a thyristor and a TRIAC.

8. Ballast circuit for operating a gas discharge lamp, the ballast circuit comprising a rectifier circuit (10) for receiving a low frequency alternating voltage, an inverter circuit (30) for providing a high frequency lamp current, and a current control circuit (30) according to claim 2 connected between the rectifier circuit (10) and the inverter circuit (30), a buffer capacitor (Cb) being connected between input terminals of the inverter circuit (30) and a diode (D3) being connected between an output terminal of the current control circuit (20) and a terminal of the buffer capacitor (Cb) to prevent current being drawn from the buffer capacitor (Cb).

9. Assembly of a gas discharge lamp (L) and a ballast circuit according to claim 7.

10. Dimmer circuit for dimming an electronic gas discharge lamp (L), the dimmer circuit comprising a TRIAC dimmer circuit (1), a current control circuit (20) according to claim 2 and a rectifier circuit (10) connected between the TRIAC dimmer circuit (1) and the current control circuit (20).

11. Current control circuit according to claim 3, characterized in that said voltage control circuit comprises a series connection of a second resistive circuit (R2) and a Zener diode (D1), a node between said second resistive circuit and said Zener diode being operatively coupled to a control terminal of a switch of said switch circuit.

12. Current control circuit according to claim 4, characterized in that said voltage control circuit comprises a series connection of a second resistive circuit (R2) and a Zener diode (D1), a node between said second resistive circuit and said Zener diode being operatively coupled to a control terminal of a switch of said switch circuit.

13. Ballast circuit for operating a gas discharge lamp, the ballast circuit comprising a rectifier circuit (10) for receiving a low frequency alternating voltage, an inverter circuit (30) for providing a high frequency lamp current, and a current control circuit (30) according to claim 3 connected between the rectifier circuit (10) and the inverter circuit (30), a buffer capacitor (Cb) being connected between input terminals of the inverter circuit (30) and a diode (D3) being connected between an output terminal of the current control circuit (20) and a terminal of the buffer capacitor (Cb) to prevent current being drawn from the buffer capacitor (Cb).

14. Ballast circuit for operating a gas discharge lamp, the ballast circuit comprising a rectifier circuit (10) for receiving a low frequency alternating voltage, an inverter circuit (30) for providing a high frequency lamp current, and a current control circuit (30) according to claim 4 connected between the rectifier circuit (10) and the inverter circuit (30), a buffer capacitor (Cb) being connected between input terminals of the inverter circuit (30) and a diode (D3) being connected between an output terminal of the current control circuit (20) and a terminal of the buffer capacitor (Cb) to prevent current being drawn from the buffer capacitor (Cb).

15. Ballast circuit for operating a gas discharge lamp, the ballast circuit comprising a rectifier circuit (10) for receiving a low frequency alternating voltage, an inverter circuit (30) for providing a high frequency lamp current, and a current control circuit (30) according to claim 5 connected between the rectifier circuit (10) and the inverter circuit (30), a buffer capacitor (Cb) being connected between input terminals of the inverter circuit (30) and a diode (D3) being connected between an output terminal of the current control circuit (20) and a terminal of the buffer capacitor (Cb) to prevent current being drawn from the buffer capacitor (Cb).

16. Ballast circuit for operating a gas discharge lamp, the ballast circuit comprising a rectifier circuit (10) for receiving a low frequency alternating voltage, an inverter circuit (30) for providing a high frequency lamp current, and a current control circuit (30) according to claim 6 connected between the rectifier circuit (10) and the inverter circuit (30), a buffer capacitor (Cb) being connected between input terminals of the inverter circuit (30) and a diode (D3) being connected between an output terminal of the current control circuit (20) and a terminal of the buffer capacitor (Cb) to prevent current being drawn from the buffer capacitor (Cb).

17. Ballast circuit for operating a gas discharge lamp, the ballast circuit comprising a rectifier circuit (10) for receiving a low frequency alternating voltage, an inverter circuit (30) for providing a high frequency lamp current, and a current control circuit (30) according to claim 7 connected between the rectifier circuit (10) and the inverter circuit (30), a buffer capacitor (Cb) being connected between input terminals of the inverter circuit (30) and a diode (D3) being connected between an output terminal of the current control circuit (20) and a terminal of the buffer capacitor (Cb) to prevent current being drawn from the buffer capacitor (Cb).

18. Dimmer circuit for dimming an electronic gas discharge lamp (L), the dimmer circuit comprising a TRIAC dimmer circuit (1), a current control circuit (20) according to claim 3 and a rectifier circuit (10) connected between the TRIAC dimmer circuit (1) and the current control circuit (20).

19. Dimmer circuit for dimming an electronic gas discharge lamp (L), the dimmer circuit comprising a TRIAC dimmer circuit (1), a current control circuit (20) according to claim 4 and a rectifier circuit (10) connected between the TRIAC dimmer circuit (1) and the current control circuit (20).

20. Dimmer circuit for dimming an electronic gas discharge lamp (L), the dimmer circuit comprising a TRIAC dimmer circuit (1), a current control circuit (20) according to claim 5 and a rectifier circuit (10) connected between the TRIAC dimmer circuit (1) and the current control circuit (20).
